(19) United States
(12) Patent Application Publication
(10) Pub. No.: US 2013/0298043 A1
(43) Pub. Date: Nov. 7, 2013

(54) System and Method for Arranging a Group Outing or Activity

(71) Applicant: Free For Friday, LLC, Charlotte, NC (US)

(72) Inventor: James Darin Bailey, Charlotte, NC (US)

(21) Appl. No.: 13/887,669

(22) Filed: May 6, 2013

Related U.S. Application Data
(60) Provisional application No. 61/643,607, filed on May 7, 2012.
(60) Provisional application No. 61/781,040, filed on Mar. 14, 2013.

(51) Int. Cl. H04L 29/06

(52) U.S. Cl. CPC H04L 65/403
USPC 715/753

(57) ABSTRACT

What is provided is a computer implemented method, system, article and tool for generating an event. The tool allows an organizer to select invitee(s) and propose an event and its details and communicate event information to the invitees over a network. The system is capable of accepting invitee proposed additional invitees and/or input event suggestions, such as but not limited to, changes to the event (optionally up to a deadline for proposing changes), where the proposals from the invitees may either be accepted by the organizer and/or sent out for a vote by the other invitees to modify the event and/or its participants (the invitees). The system is capable of receiving invitee(s) attendance responses.

### CROSS REFERENCE TO RELATED PATENTS

This application claims priority to and the benefit of the filing date of U.S. provisional patent application No. 61/643,607, filed May 7, 2012 and U.S. provisional patent application No. 61/781,040, filed Mar. 14, 2013.

### BACKGROUND

1. Field

The system relates to online software for event planning.

2. Background

Time and energy are at a premium in today's world, and it is not desirable to waste either. The back and forth communication required to plan an outing may be frustrating and problematic. This problem is widespread. Some online tools exist to survey feedback or to send invitations, however these do not easily facilitate the entire planning process. For instance, Evite® allows an organizer to determine the time and place for an event, but does not solicit ideas and allow voting by invited guests. Meetup® allows for setting up a meeting group but leaves this open for anyone to join in and does not facilitate the gathering of ideas and voting.

The Internet is easily accessible, therefore a properly designed online planning tool that facilitates the entire outing planning process would make it easier to communicate and decide where and when to go.

Accordingly, what is provided is a system, tool, article and computer implemented method that facilitates the planning on an outing (e.g. group trip, social gathering, event) by allowing invited participants to submit ideas and/or vote on event data, such as but not limited to, where and/or when to go, using an online tool and configurable process flow.

The system, tool, article and computer implemented method may be used, for example, by a group of friends planning a guy's trip and want to decide where and when to go this upcoming ski season. An organizer sets up this outing and configures it to solicit ideas and allow voting on where and when to go by those invited to this outing. The organizer suggests Vail, CO while other invitees suggest Mammoth, Calif. and Park City, Utah. The group also suggests different dates. Ideas are no longer accepted once a deadline for submitting ideas has expired, and the group now is allowed to vote on when and where to go. Votes are no longer accepted once a deadline for voting has expired, and the group now is allowed time to review the results and RSVP to the outing. For convenience, anyone in the group can RSVP anytime and the organizer can make changes, add suggestions, extend deadlines, break voting ties, address no-vote situations, and override any input provided also at anytime. Of course, this is merely but one possible use depicting possible settings for the present system and further examples are contemplated within the scope and spirit of this application.

### BRIEF DESCRIPTION OF THE DRAWINGS

In the drawing(s):

FIG. 1 is a block diagram of the system.

FIG. 2 is a diagram of several alternative process flows of the system, where FIG. 2a is the process flow for planning a group outing or activity without soliciting ideas or votes, FIG. 2b is the process flow for planning a group outing or activity while soliciting ideas but no votes, FIG. 2c is the process flow for planning a group outing or activity and requesting votes on ideas suggested by the organizer, FIG. 2d is the process flow for planning a group outing or activity while soliciting ideas and putting ideas up for a vote, FIG. 2e is the process flow following the RSVP deadline, and FIG. 2f is the process for cancelling a group outing or activity.

FIG. 3 is a diagram of the process flow in accordance with an example of the present system.

FIG. 4 is a sample screenshot of an invitation feature in accordance with an example of the present system.

### DETAILED DESCRIPTION

Unless defined otherwise, technical and scientific terms used herein have the same meaning as commonly understood by one of ordinary skill in the art to which this example belongs. One skilled in the art will recognize systems and methods similar or equivalent to those described herein, which could be used in the practice of the present system examples., The present system examples are in no way limited to the specific example system, tool and methods described herein. Some of the system and tool features described can be used to advantage without the corresponding use of other features. For example, participant voting may be used with or without participant submitted ideas, and participant idea submissions may be used with or without participant voting. For example, deadlines may optionally be set for one, both or neither of participant idea submission and participant voting.

Some portions of the detailed description are presented in terms of process or symbolic representations of functionality of the system or tool that is performed by a computer on data bits and/or binary digital signals stored within a computing system. Such operations of the present system or tool are intended to be performed by a computer and/or may not be performed without a computer. In this manner, the computer implemented system or tool necessarily involves use of a computer and divorcing the methods or processes described herein from a computer, such as to read them to encompass unpatentable mental steps performed by a human user without use of the present computer-implemented system, is not intended within the scope and spirit of this application.

This computer-implemented system or tool may be described in terms of flow charts, system diagrams, system architectures, process descriptions and/or representations, which are descriptions used by those of ordinary skill in the data processing arts to convey the substance of their work to others skilled in the art. System processes may be codified into computer readable instructions, such as by implementation of one or more algorithms, representing the process. The instructions may be stored in memory of various medias, which may tangibly embody them. The operations and/or processing may involve physical manipulations of physical quantities. Typically, although not necessarily, these quantities may take the form of electrical and/or magnetic signals capable of being stored, transferred, transformed, combined, compared and/or otherwise manipulated. These signals may be referred to as bits, data, values, elements, symbols, characters, terms, numbers, numerals and/or the like. By performing the instructions to process the data, tangible results are produced. For example, a tangible electronic invitation may be issued by performing the instructions of the current system. It should be understood that all of these and similar terms are to be associated with appropriate physical quantities and are merely convenient labels.

It is appreciated that throughout this specification discussions utilizing terms such as “generating,” “issuing,” “initiating,” “providing,” “setting,” “processing,” “inviting,” “communicating,” “receiving,” “modifying,” “computing,” “calculating,” “determining,”“storing,” “importing,” and/or the like refer to the actions and/or processes of a computing system, such as a computer or a similar electronic computing device that manipulates and/or transforms data represented as physical electronic and/or magnetic quantities and/or other physical quantities within the computing platform's processors, memories, registers, and/or other information storage, transmission, and/or display devices. it is appreciated that throughout this specification discussions utilizing terms such as “receiving,” “reporting” “communicating,” “inviting,” “importing,” and/or “displaying” and the like may refer to use of a graphical user interface (GUI) of the system or tool to accept user input data and/or display system or user supplied data. Such a computer may tangibly embody the processes, methods, system and/or tool described herein.

A computer includes, but is not limited to, a device such as an electronic computing device that manipulates and/or transforms data represented as physical, electronic and/or magnetic quantities and/or other physical quantities within the computing platform's processors, memories, registers, and/or other memory, information storage, transmission, reception, I/O and/or display features or devices. Accordingly, a computer refers to a system, a device, an article and/or a logical construct that includes the ability to process and/or store data in the form of signals. A computer may comprise hardware, software, firmware and/or any combination thereof. It may include desktop, laptop, mobile device, handheld, tablet, smartphone and other implementations capable of being connected to the Internet via local, remote, WIFI, cellular and/or other networks.

Where it is described that a user inputs data to the system, makes a setting or parameter selection, or instructs a computer to perform a certain action, it is understood that the computer implemented system may perform a task as a result of a selection or action by a user, but that the user, the user's decisions and/or mental steps are not intended to be included in the system. Rather, the system provides features and functionality for tasks that may be accomplished by the system in response to data received. The computer implemented system or tool is capable of receiving or accepting user data or input, communicating, reporting and/or displaying such data, and/or performing calculations, functions and/or operations upon, using or based at least in part upon such data. A user may input data and/or instruct a computer to perform tasks via an indication of a parameter or setting selection, including, for example: manually typing in data; pushing a button or key; clicking or rolling a mouse; rolling a tracking ball; clicking, swiping or gesturing of a touchpad; using a tablet pen on a screen; maneuvering a pointer; touching, swiping or gesturing on a touch screen; and/or by audible or verbal sounds.

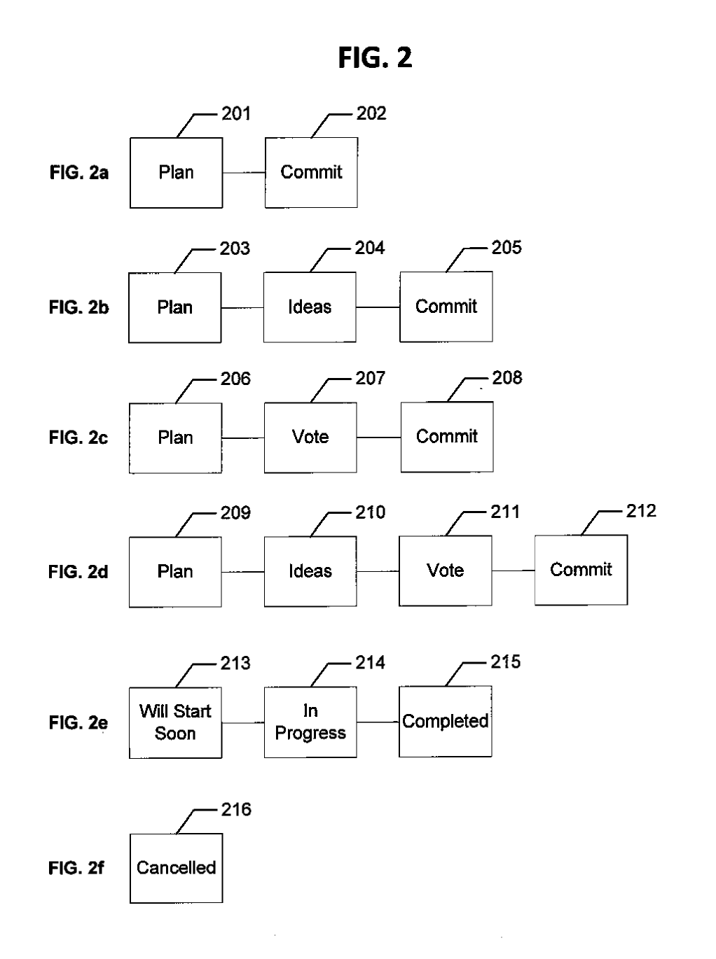

Flowcharts are used herein to illustrate certain aspects of some example system features and possible system settings. Logic they illustrate is not intended to be exhaustive of any, all, or even most possibilities. For example, FIG. 2 shows multiple possible alternate setting configurations and uses of the present system, but does not describe all possible uses of the present system. More uses, setting or parameter selections and various combinations thereof are intended.

Throughout this specification, the term system may, depending at least in part upon the particular context, be understood to include any method, process, apparatus, device, tool, article and/or other subject matter implementing one or more processes, instructions, features or functionalities disclosed herein.

This technology facilitates the interaction of people and businesses and the decision making process when planning an outing (e.g. an event, social gathering, reunion, or group trip) (“Planning An Outing”). This interaction can be complex and may vary event to event. The planning process of this system and/or tool may include, but is not limited to, features and/or functionality related to accomplishing the following possible activities when Planning An Outing:
(1) identifying the organizer (“Organizer”);
(2) generating and/or issuing one or more invitations to invite one or more others (“Invitees”) and notifying them;
(3) receiving and/or reporting one or more location suggestions—Organizer may decide without soliciting suggestions from others OR the system may generate one or more solicitations for location suggestions from Invitees and receive and report such location suggestions (Organizer may or may not provide suggestions);
(4) receiving and/or reporting one or more date/time suggestions for the event—Organizer may decide without soliciting suggestions from others OR the system may generate one or more solicitation for date/time suggestions from Invitees and receive and report such location suggestions (Organizer may or may not provide suggestions);
(5) reporting location selection (Organizer makes final decision OR the system and/or tool may generate a vote for Invitees (and/or the Organizer) to vote upon location suggestions, tabulate the votes, and report the location selection results);
(6) reporting date/time selection (Organizer makes final decision OR the system and/or tool may generate a vote for Invitees (and/or the Organizer) to vote upon date/time suggestions, tabulate the votes, and report the location selection results;
(7) receive and report input from Invitees, such as regarding additional suggested invitees, change(s) in event location selection, change(s) in location date/time selection, and/or other information;
(8) starting over;
(9) generating and reporting a list of items to bring to the event, receiving Invitees and/or Organizer input for signing up to bring one or more items on the list, and reporting item sign-ups and/or editing the list to indicate that item(s) have been selected or to remove items that have been selected;
(10) generating and reporting a list or a sign-up for who is planning portions of the outing (e.g. travel, dining, lodging, activities);
(11) communicating event information and updates to users;
(12) receiving and reporting Organizer and Invitees response information regarding whether or not they are attending the outing;
(13) receiving and reporting, data regarding Organizer and/or Invitee(s) user suggestions for a gift for Organizer and/or host and/or attendees, and/or generating a vote for a gift, tabulate the votes, and report the gift selection results;
(14) arranging, reserving and/or scheduling air travel, lodging, ground transportation, dinner reservations and other reservation services based upon Organizer and/or Invitee(s) user supplied data.

The numbered actions are not necessarily intended to be performed in the order presented and are numbered merely for convenience for facilitating understanding of this description. This system and/or tool may enable an Organizer and Invitee(s) to leverage previously planned outings to serve as the basis for a new outing by referring to a database relating to past activities, events or outings. The following includes, but not limited to, the possible scenarios when leveraging a previous outing:
(1) generating an outing with the same location as a previous outing but for a different day and time;
(2) scheduling an outing with the same date as a previous outing but for a different location;
(3) generating an outing and inviting the same Invitees from one or more previous outings;

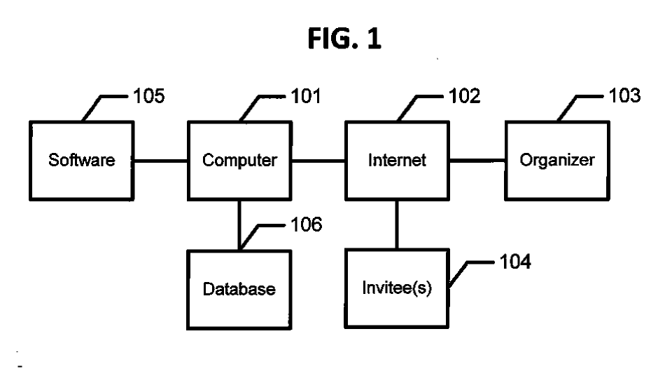

FIG. 1 is a block diagram of one illustrative system for practicing the present method, article, system and/or tool. A computer at block 101 serves as a storage device for the method, system and/or tool and may tangibly embody the method, system and/or tool. Storage includes, but not limited to, a software program at block 105, a clock, data, and other supporting systems such as an operating system, web server, and database at block 106. As described above, a computer may include various desktop, laptop and mobile devices, etc., and various hardware, software, firmware, etc. and is not intended to be limited to a PC. This computer at block 101 is connected to the Internet at block 102, which provides a connection to and access by the Organizer at block 103 and the Invitee(s) at block 104, both of which are also connected to the Internet at block 102 using various devices including, but not limited to, a web browser on a personal computing device or an application on a mobile device. The computer at block 101 executes certain business logic to process commands set by the software program at block 105 based on certain input parameters for the purpose of establishing two-way communication to the Organizer at block 103 and to the Invitee(s) at block 104. Communication methods include, but are not limited to, a graphical user interface rendered within a web browser and notifications sent and delivered via email, SMS or push notification to a mobile application. The database at block 106 includes addresses of recipients and data regarding past activities, outings and/or events that may be referenced (and adapted, augmented or modified, if desired) for reuse as desired by the Organizer.

FIG. 2 is a diagram of the various alternative process flows used for facilitating the planning of an outing on behalf of and for the benefit of the Organizer and/or Invitee(s). During an initial setup, the Organizer may choose whether to allow Invitee(s) to submit ideas and/or vote (“Settings”). Based on these Settings, the process flow is configured. Changes to the outing may change the process flow. Below are the different scenarios and process flows per one of the alternative configurations that may be selected by the Organizer during setup:
(1) During the Plan stage at block 201 in FIG. 2a, the Organizer configures the outing to not solicit Invitee(s) for ideas and to not enable voting by Invitee(s). After setup completion, invitations are sent out and the outing enters the Commit stage at block 202 whereby the Organizer and Invitee(s) may RSVP up until a specified deadline;
(2) During the Plan stage at block 203 in FIG. 2b, the Organizer configures the outing to solicit Invitee(s) for ideas, but not enable voting by Invitee(s). After setup completion, invitations are sent out and the outing enters the Ideas stage at block 204 whereby the Organizer and Invitee(s) may submit ideas up until a specified deadline. Once this deadline has expired, the outing enters the Commit stage at block 205 whereby the Organizer and Invitee(s) may RSVP up until a specified deadline;
(3) During the Plan stage at block 206 in FIG. 2c, the Organizer configures the outing to not solicit Invitee(s) for ideas, but enable voting by Invitee(s). After setup completion, invitations are sent out and the outing enters the Vote stage at block 207 whereby the Organizer and Invitee(s) may cast vote(s) up until a specified deadline. Once this deadline has expired, the outing enters the Commit stage at block 208 whereby the Organizer and Invitee(s) may RSVP up until a specified deadline;
(4) During the Plan stage at block 209 in FIG. 2d, the Organizer configures the outing to solicit Invitee(s) for ideas and enable voting by Invitee(s). After setup completion, invitations are sent out and the outing enters the Ideas stage at block 210 whereby the Organizer and Invitee(s) may submit ideas up until a specified deadline. Once this deadline has expired, the outing enters the Vote stage at block 211 whereby the Organizer and Invitee(s) may cast vote(s) up until a specified deadline. Once this deadline has expired, the outing enters the Commit stage at block 212 whereby the Organizer and Invitee(s) may RSVP up until a specified deadline;

Once the deadline has expired for the Commit stage at block 202, 205, 208, or 212, the outing enters the Will Start Soon stage at block 213 in FIG. 2e until the outing start date and time. Once the outing starts, the outing enters the In Progress stage at block 214 until the outing end date and time. Once the outing ends, the outing enters the Completed stage at block 215.

The Organizer may cancel an outing at block 216 in FIG. 2f. The Organizer may also delete an outing using block 216. When an outing or other activity is cancelled or deleted, those invitees are provided a notice (e.g. in the form of an email message, text message, etc.) to that effect with whatever explanation the Organizer cares to include (e.g., event x cancelled due to lack of interest; event y cancelled due to weather; event z cancelled and will be rescheduled for next year, etc.). Of course, these are merely a few possible examples of manners in which the current system, tool and methods may be used and system or tool settings or parameters may be enabled or disabled, and other examples are possible within the scope and spirit of this application.

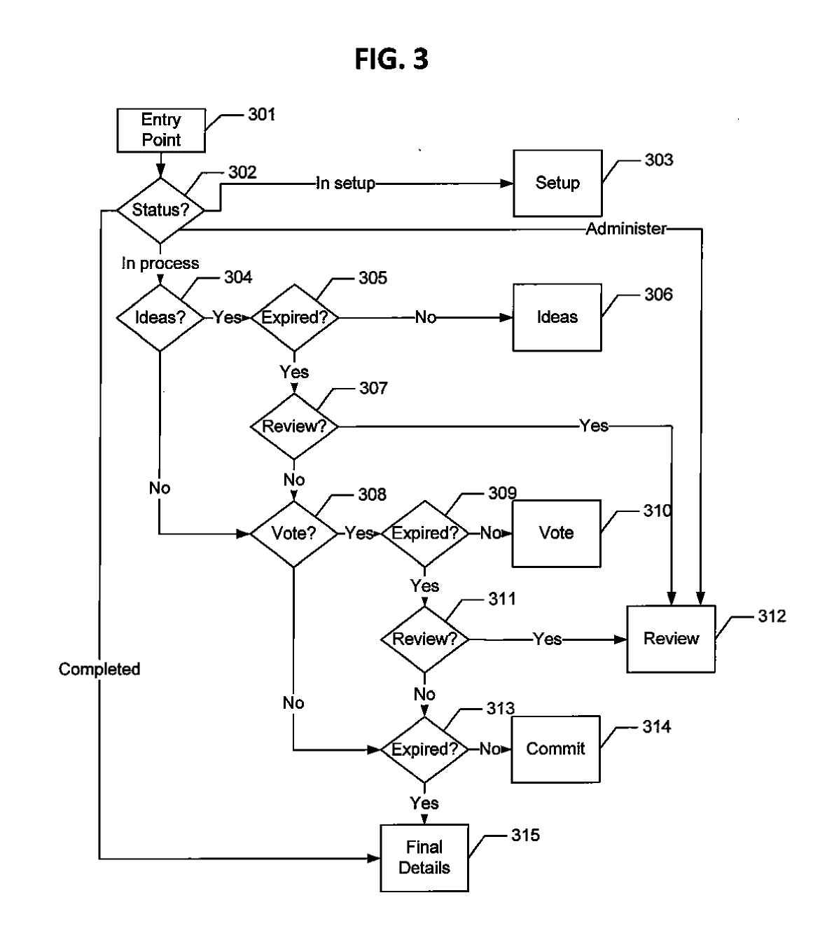

FIG. 3 is a high-level process flow diagram of a system for collecting and/or receiving data from a user (the “Organizer”) to initiate and administer event planning and to enable at least one other participant invited (the “Invitee”) to participate based on certain parameters or settings set by the Organizer such as receiving Invitee submitted ideas for Organizer and/or other Invitee review, consideration, use in system generated voting, and receiving user input event attendance data, such as that indicating user acceptance or declination of the invitation, each with their own response deadline. This is merely one possible example of certain selections of some system features.

The entry point at block 301 applies to both the Organizer and the Invitee (collectively the “Members” or “users”) and is accessed by a graphical user interface of the system/tool capable of being displayed upon a computer and/or other user device, such as a mobile device, using a communication method including, but not limited to, a link or button on a web page within a web browser on a personal computing device or link or button within an application on a mobile device. The system is capable of receiving Organizer supplied data for initiating the planning process for a new event or administering an existing event from the entry point at block 301. Both the Organizer and Invitee(s) access the event from the entry point at block 301 in order to view the event details via the graphical user interface (GUI) of the system and provide input to the system, as permitted by the Organizer selected system/tool settings during setup and administration of the event. These input data capable of being received by the system may include, but is not limited to, the addition and/or removal of Invitees, submission or removal of one or more ideas, voting, and confirmation of attendance.

Status of the event is determined at block 302 in order to present the appropriate information to the Organizer or Invitee. The system may compute event status based upon planning, ideas submission, voting, commit, cancelled, edited, closed, completed, new, existing and/or other status indicators. One or more statuses may be based at least in part upon optionally set deadlines for various tasks.

Depending on the status of the event as determined at block 302, the Organizer may use the present system or tool to setup a new event at block 303 or complete the setup of an existing event at block 303 or administer an existing event at block 312. The present system is capable of generating and/or scheduling a new or existing event based upon user supplied data. To use the system to generate an event, the Organizer identifies the event by giving it a title and providing related information at block 303 or at block 312 including (in one example, but optionally) one or more ideas for proposed location and one or more ideas for proposed date or timeframe. The system is capable of receiving one or more Organizer user supplied event titles and related information, such as event location and/or timeframe data. Other identifying information may be used instead of or in addition to event title and the like. The Organizer invites others, decides whether to assume that they are coming or not coming, and decides whether to or not to allow Invitees to extend invitations to others (“Additional Invitees”) at block 303 or at block 312. The system includes functionality for generating an event Invitee list based upon Organizer user supplied data. It includes one or more settings capable of being selected by an Organizer user for a system parameter to be set by the system as to whether Invitees are deemed to be attending the event or not attending the event if an Invitee does not RSVP or respond to an event invitation. The system includes functionality for allowing Invitees to extend event invitations to others. If the Organizer has selected a system setting for allowing Invitees to extend invitations to others, then the system may provide functionality allowing the Organizer to review and approve additional Invitees prior to being added as a Member of the event, if selected by an Organizer user. The system includes settings that may be selected for limiting the time period within additional Invitees may be added, such as to disallow additional invitations from being extended after the commitment deadline.

The system also may include a setting capable of being selected by the Organizer to place a minimum and/or maximum limit on the total number of Members required/allowed for the event at block 303 or at block 312. The system may include a setting capable of being selected by the Organizer that may allow Invitee(s) to respond to the invitation with a “maybe” attending at block 303 or at block 312. The system may include a setting capable of being selected by the Organizer for allowing Invitees to submit their own ideas and/or votes for one or more or each of the location and the date or timeframe at block 303 or at block 312. If the Organizer selects the system setting that allows for idea generation by Invitees, then the Organizer may optionally set a deadline for idea submission by selecting a system setting for creating such a deadline. If the Organizer selects the system setting that allows for voting by Invitees, then the Organizer may optionally set a deadline for Invitees to cast their vote by selecting a system setting for creating such a deadline. The system my allow the Organizer to provide additional comments or instructions. The system may include a further setting capable of being selected by the Organizer to set a deadline for accepting or declining the invitation. One or more or each of these deadlines may be set at block 303 and/or at block 312.

As the Members access this information at block 301 and, if the event is in process at block 302, then the program determines at block 304 if Members are allowed to submit and/or change their idea(s). If Members are permitted to submit their ideas for the location and/or the date or timeframe, then they may do so at block 306 up until a deadline at block 305 set by the Organizer at block 303 or at block 312. Upon deadline expiration at block 305, the program examines the results at block 307 to determine if the Organizer needs to review the event prior to proceeding to the next step. If no ideas were generated by the Members, then the tool may execute the following: (1) notify the Organizer that no ideas were generated by the Members, in which the Organizer may review the results and take corrective action by adding ideas, by selecting system settings for extending the deadline, allowing the planning process to continue without ideas, making other changes to the event that makes it no longer in the ideas step, or canceling the event at block 312 and (2) optionally the system may automatically or based upon manual selection notify Invitees of one or more statuses and/or status changes of the event and of any updates made by the Organizer. If the Organizer has completed the review and has taken corrective action at block 312, then the program determines if the Member is permitted to cast or change their vote for an idea at block 308. If the ideas deadline has expired at block 305 and there are one or more ideas and the event does not require a review by the Organizer as determined at block 307, then the program determines if the Member is permitted to cast or change their vote for an idea at block 308, as set by selection of one or more settings or parameters of the system or tool. If the Members are not permitted by the Organizer to submit their idea(s) at block 304, then the program determines if the Organizer has permitted the Members to cast or change their vote for an idea at block 308.

If the system settings are selected such that Members are permitted to cast their vote, then they may cast their vote at block 310, which illustrates that the system is capable of receiving or accepting user input votes, up until a deadline at block 309, which may be optionally set by the Organizer at block 303 or at block 312. Upon deadline expiration at block 309, the program examines the results at block 311 to determine whether to display the results for review by the Organizer and/or to notify the Organizer of the results with an indication that review or manual action or further selection of system settings is recommended, prior to proceeding to the next operation. For example, if no votes were casted by the Members or if there is a voting tie, the system then may execute the following: (1) notify the Organizer that there is an issue with the voting results (voting tie or no votes were submitted by the Members), in which the Organizer can review the results and take corrective action by manually inputting final selections, by extending the deadline, by making other changes to the event that makes it no longer in the voting step or by canceling the event at block 312 and optionally (2) notify Members of the status of the event and of updates made by the Organizer while under review. Various system operations may be enabled by Organizer selection of various system settings or parameters. If the Organizer has completed review and has taken corrective action at block 312 and the commit deadline has not expired at block 313, then the program captures and makes available the event details for consideration of accepting or declining by each Member at block 314. If the voting deadline has expired at block 309, the voting results do not include review by the Organizer at block 311, and the commit deadline has not expired at block 313, then the program captures and makes available the event details for consideration of accepting or declining by each Member at block 314. If the Members were not allowed to vote at block 308 (based upon selection of system settings) and the commit deadline has not expired at block 313, then the program captures and makes available the event details for consideration of accepting or declining by each Member at block 314. If the commit deadline has expired at block 313, then the program captures and makes available the final event details at block 315. Other examples may allow for ideas input and/or voting by some but not all Members.

Members may accept or decline an invitation at any point in the process e.g. blocks 306, 310, 312, 314 so long as certain system parameters for conditions set by the Organizer at block 303 or at block 312 allow for it, such as an established threshold for a maximum number of Members has not been met or commitment deadline has not expired at block 313. In some examples, no limiting settings may be employed.

The Organizer may review and make changes at any point in the planning process e.g., at blocks 303, 306, 310, 312, 314, 315.

When the event commitment deadline has expired at block 313, the event is considered complete unless the Organizer makes changes at block 312 that would otherwise change the event's status. When Members access the event at block 301, the program at block 302 determines the status of the event. If the event has been completed, the program will present the event details at block 315.

Members may be notified of one, some or all changes made, ideas submitted, votes casted, whom is attending, final details, and other related information through various commercially-available communication systems and methods, such as SMS, email, web-based applications, mobile applications, and other communication systems and methods.

FIG. 3 shows merely one possible example of functionality and features possible for the event planning tool of this application. It includes optional features not required for other examples of the event planning tool, system and methods of the present application. For example, the deadlines are optional, and the Organizer may disable one or more system features, based upon setting selections. For example, the Organizer may choose to individually enable/disable Invitee ideas submission, Invitee voting, RSVP assumptions, etc. Other example tools, systems and methods may have various different combinations of features, settings and functionality enabled and/or disabled.

Further, the application is not intended to be limited to the specific event data described herein. Although Invitee idea submissions and voting are discussed with reference to event location and event scheduling data, the present system, tool, article and method are not so limited. Rather, other possible example of data for which Invitees may submit idea data and/or Invitee voting may take place, may include but are not limited to, packing lists, menus, potluck food sign-ups, activity choices, among many others. The present system, tool, article and computer implemented method may be used to solicit and/or vote upon many aspects and details of an event. For example, for planning a concert event, the system may be used for staging choices, lighting choices, music choices, arrangement selections, performer selections, performer costumes, set lists, and the like. For example, for planning a family reunion event, the system may be used to finalize lists of invitees, lists of attendees, reunion location, reunion date and time, activities to do during the reunion, planning for menu and who will bring what, planning for showing family movies or displaying family photos, etc. There are many types of data for which the present tool may be used to solicit and/or vote upon.

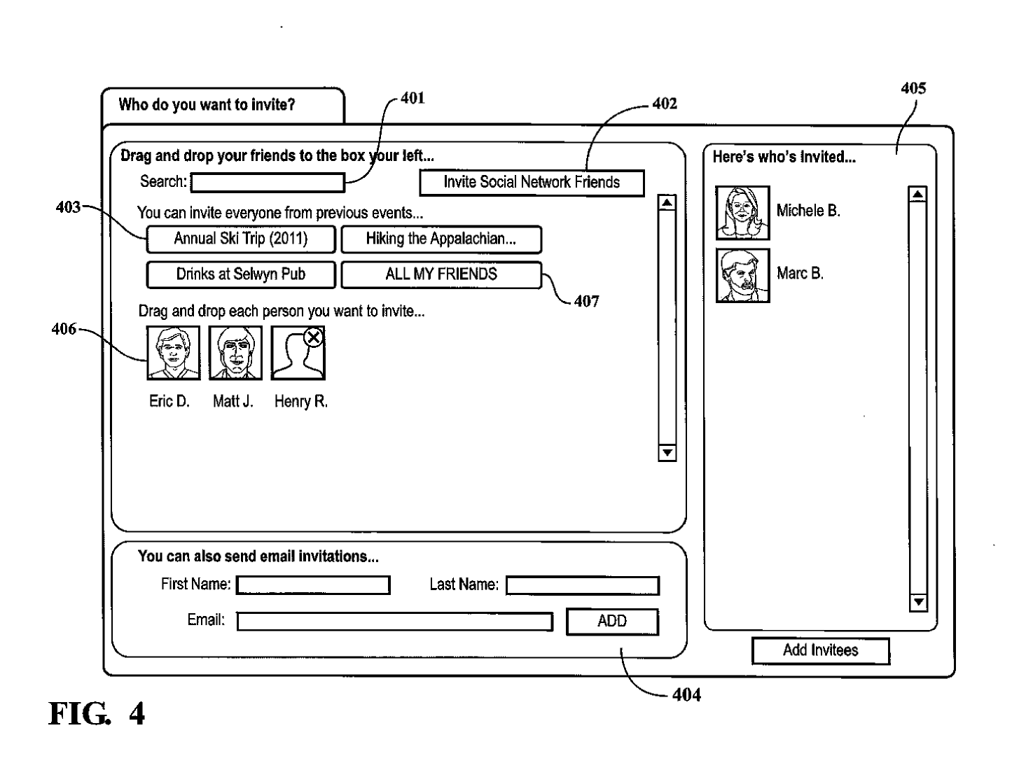

FIG. 4 is a sample graphical user interface (“GUI”) to illustrate the invitation feature of the system.

Members can invite friends, family, business colleagues, and others (collectively the “Contacts”), e.g., using a GUI with a drag-and-drop feature. Contacts may be added from third party sources at block 402. By way of example, some commercially available third party sources that may be used to supply the user with contacts to invite to an event in connection with the system include, but are in no way limited to, Facebook®, Google®, and YAHOO!®. Contacts may be added individually from a list of contacts at block 406 or manually by entering a name and email address at block 404. Contact may be added in bulk from a group of contacts who attended another event at block 403 or from by adding all of their Contacts at block 407.

The GUI provides a search function 401 in order to find and present contacts based on input provided by the Member.

Members may click on a contact at block 406 and then drag and drop this contact into the area listing those being invited 405. In another example, Members may click once to select a contact and/or group of contacts and then click a second time in the area listing those being invited 405, without utilizing a drag and drop type of selection input. For example, Members may click upon a plus sign next to a contact or group of contacts and click in a field within the invitee field on the GUI to add the contact(s) to the event. Single click examples may be possible as well. Similarly, in an example, Members may click upon an “X” image near a contact and/or group of contact to remove the contact from the event.

Members may click on a previous event at block 403 and then drag and drop this previous event into the area listing those being invited at block 405 which will add all contacts that were Members of that event. In another example, Members may click once the previous event and then click a second time in the area listing those being invited at block 405, to invite all contacts from that previous event with a single click, without utilizing a drag and drop type of selection input. Members may also click on all of their contacts at block 407 and then drag and drop (or input the selection by tapping on a button, field or image) into the area listing those being invited 405 that will add all of that user's contacts as Invitees to the event.

Current Invitees are listed along with those added by Member at block 405 as described above. Members can add new Invitees to the event by clicking the corresponding button at block 405. Members can remove those Invitees that were invited by that Member. The Organizer can remove any Invitee.

The GUI may also include a field capable of receiving or accepting user input event suggestions, such as but not limited, event location ideas, event date ideas, event timeframe suggestions, and the like. The user input suggestions may be compiled by the system into one or more listings, which may be used in the system voting functionality, as described above.

The GUI may include a voting field capable of receiving or accepting user input votes regarding event information, such as votes for a listing of event data supplied by the Organizer and/or system generated based upon the Invitee suggestions. The GUI may contain one or more fields for displaying voting results. It may contain further fields for displaying further event information. This is merely one possible GUI examples and others are possible for displaying system content and/or receiving user inputs.

The GUI may include one or more images to communicate event status. For example, it may include a timeline, event status indicator or listing to communicate various planning stages, deadline timeframes and the like.

An example of the present system has been described with some specificity in the foregoing description, but many modifications and variations are possible without departing from the spirit of the present application. Further, some features (such as member voting and modification of the event) can be used to advantage in the present system without corresponding use of other features (such as an invitations system where the Invitees can propose or invite further members). Thus, the descriptions presented in this document are merely illustrative of the principles of the present system and not in limitation thereof.

Of course, many modifications and alterations to the present method and system can be made without departing from the spirit of the present application. Further, some of the features can be used without the corresponding use of other features. Additional features can be added, if desired. For example, if the outing included going to a restaurant, links can be provided to the menu for the restaurant. If the outing is a visit to another city, a link can be provided to events scheduled in that city and/or the local Chamber of Commerce website. Ads or links related to the content can also be provided—for example, travel providers, such as common carriers, local attractions, local entertainment and/or accommodations can be provided based on a set of stored rules (in the software program at block 105) and/or based on compensation from the ad provider. The ads or links can be from the database at block 106 or generated from a tool such as www.travelocity,com, www.google.com or www.dogpile.com, either directly or with editing and selection, as by the Organizer. Many of the settings outlined in connection with an outing above are optional at the selection of the Organizer and/or Invitees, such as deciding on a gift for the Organizer and booking lodging (which only applies to an event requiring lodging). It will be apparent to one of ordinary skill in the relevant art that many other modifications and adaptations can be made without departing from the spirit of the present system.

What is claimed is:

1. A system for generating an event comprising:
a graphical user interface capable of being displayed on a computer display, the graphical user interface is capable of receiving input data from an organizer user and one or more invitee users and displaying one or more event data;
a processor capable of generating the event based upon electronically stored instructions for generating an event based at least in part upon the organizer input data, the organizer input data comprising event data and one or more setting selections capable of enabling invitee users to input one or more event idea data; the electronically stored instructions further comprising instructions for generating an invitee voting of event data and/or event idea data and generating a final event data based at least in part upon a tabulation of invitee votes and/or organizer input event data;
the system capable of accepting invitee attendance response data input on the graphical user interface;
a database capable of storing the organizer and invitee user input data and event data, the stored event data capable of being imported into a second event by the system.; and
an electronic communications system capable of issuing one or more communications over a network to the organizer and/or invitee users regarding the event data.

2. The system of claim 1, the electronically stored instructions further comprising instructions for setting one or more deadlines for accepting the invitee input event and/or invitee votes and/or invitee attendance response data.

3. The system of claim 1, the organizer input data further comprising invitee user data, the system capable of generating a listing of invitee users for an event based upon manually input invitee data and/or invitee data imported by the system from an external source, the listing capable of being imported by the system into a second event.

4. The system of claim 1, the electronically stored instructions further comprising instructions for editing event data and generating a second voting for the edited event data.

5. The system of claim 1, the event data comprising event location and/or event scheduling data.

6. An article comprising: a storage medium having stored thereon instructions that, if executed, enable a computer to:
receive by a computer implemented event planning system, organizer user input data comprising invitee data, event data and one or more selections of one or more system settings, at least one system setting capable of enabling invitee user input of event suggestion data, the organizer and invitee user input data capable of being received and displayed by a graphical user interface displayed on the computer, at least one system setting capable of setting one or more deadlines;
generate an event, by a processor executing the electronically stored instructions, and based at least in part upon the organizer user input data;
invite one or more invitees to the event by issuing one or more electronic communications capable of being sent over a network, based upon the invitee data;
receive the event suggestion data input on the graphical user interface, if the invitee input setting is enabled;
set one or more deadlines for acceptance of the event suggestion data, if the deadline setting is enabled, by the processor executing the electronically stored instructions;
modify the event data, by the processor executing the electronically stored instructions, based at least in part upon the event suggestion data and/or a further organizer input event data; and
communicate the modified event to the invitees by issuing one or more electronic communications capable of being sent over a network.

7. The article of claim 6 having further instructions stored thereon instructions that, if executed, further enable the computer to:
generate a voting of at least a portion of event data and/or event suggestion data, by the processor executing the electronically stored instructions;
receive organizer and/or invitee user input votes for the event data and/or event suggestion data, on the graphical user interface;
tabulate the votes by the processor executing the electronically stored instructions and display tabulation results on the graphical user interface;
set one or more deadlines for acceptance of the votes, if the deadline setting is enabled, by the processor executing the electronically stored instructions; and
modify the event data, by the processor executing the electronically stored instructions, based at least in part upon the tabulation results and/or a further organizer input event data.

8. The article of claim 7 having further instructions stored thereon instructions that, if executed, further enable the computer to:
review the event suggestion data and/or tabulation results, by the processor executing the electronically stored instructions;
issue a communication to the organizer if no event suggestion data and/or invitee votes have been received and/or the tabulation results include a tie;
provide the organizer a setting for extending the deadline for receipt of event suggestion data and/or votes, if the deadline setting is enabled;
provide the organizer settings for editing and/or cancelling the event.

9. The article of claim 7 having further instructions stored thereon instructions that, if executed, further enable the computer to:
generate more than one voting of event data; and
modify the event data based upon the results of the multiple votings.

10. The article of claim 7 having further instructions stored thereon instructions that, if executed, further enable the computer to:
provide one or more settings for allowing the organizer to disable invitee submission of event suggestion idea data and/or invitee voting.

11. The article of claim 6, the event data comprising event location data and event schedule data.

12. The article of claim 6 having further instructions stored thereon instructions that, if executed, further enable the computer to:
generate a listing of invitees based at least in part upon the invitee data;
store the invitee listing and event data in memory; and
import the invitee listing and/or event data for a second event.

13. The article of claim 6 having further instructions stored thereon instructions that, if executed, further enable the computer to:
provide one or more settings for enabling invitee editing of the event suggestion data.

14. The article of claim 6 having further instructions stored thereon instructions that, if executed, further enable the computer to:
provide a setting capable of being selected by the organizer for enabling the invitees to issue invitations to one or more additional invitees for the event.

15. The article of claim 14 having further instructions stored thereon instructions that, if executed, further enable the computer to:
provide a setting capable of being selected by the organizer for approving invitations to the additional participants prior to being issued.

16. The article of claim 6 having further instructions stored thereon instructions that, if executed, further enable the computer to:
generate an event attendance response request for the invitees; and
tabulate invitee attendance responses.

17. The article of claim 16 having further instructions stored thereon instructions that, if executed, further enable the computer to:
provide one or more settings capable of being selected by the organizer for automatically determining that an invitee is attending the event and/or is not attending the event, if the event attendance response is not received from the invitee.

18. The article of claim 16 having further instructions stored thereon instructions that, if executed, further enable the computer to:
provide a setting for setting a minimum or maximum number of invitees for the event.

19. A computer implemented tool capable of generating a customized event comprising;
a set-up tool capable of receiving organizer input event data and invitee data on a graphical user interface, the set-up tool comprising one or more settings for configuring the event, at least one of the settings capable of being selected to enable one or more invitee data inputs and/or one or more invitee voting inputs regarding at least a portion of the event data, the set-up tool capable of issuing one or more event invitations to one or more invitees over a network based upon the invitee data;
an invitee data input tool capable of receiving the invitee data inputs, assembling one or more listings of the invitee data inputs and displaying the listings on the graphical user interface, the invitee data input tool further comprising a parameter for setting a deadline for accepting the invitee data inputs;
a voting tool capable of generating a voting of the organizer input event data and/or invitee data inputs and receiving the invitee voting inputs, the voting tool capable of tabulating the voting inputs, and displaying one or more results of the tabulation on the graphical user interface, the voting tool further comprising a parameter for setting a deadline for accepting the voting inputs;
the tool capable of setting a final event data based upon the tabulation results and/or an organizer input final event data; and
a commit tool capable of updating the event with the final event data, the commit tool capable of receiving organizer and invitee event attendance response data, the commit tool further comprising a parameter for setting a deadline for accepting the invitee event attendance response data.

20. The tool of claim 19, the event data comprising event location data and/or event scheduling data, the set-up tool capable of selectively enabling invitee input for the event location, the event scheduling, both the event location and the event scheduling, or neither of the event location or the event scheduling, the set-up tool further capable of selectively enabling invitee data inputs and/or invitee voting inputs for the event location and/or the event scheduling,

21. A computer implemented method of event planning comprising:
initiating a new event based upon receiving event data input from an organizer to a computer implemented event planning system;
issuing an electronic event invitation for the event to one or more participants, the electronic event invitation capable of being sent over a network;
providing a graphical user interface in the computer implemented event planning system capable of accepting the data input by the organizer and capable of being displayed on a computer implementing the computer implemented event planning system;
generating a participant voting for at least a portion of the event data;
providing functionality in the computer implemented event planning system capable of receiving one or more participant votes for the event data and tabulating the votes;
setting a final event data based at least in part upon the votes and/or further organizer input event data and displaying the final event data on the graphical user interface; and
providing functionality in the computer implemented event planning system capable of receiving one or more participant event attendance responses.

22. The computer-implemented method of claim 21, further comprising:
providing in the computer implemented event planning system a setting for enabling the participants to input event idea data, the setting is adapted to be set by the organizer;
receiving participant submitted event idea data and displaying the event idea data on the graphical user interface;
generating participant and organizer voting of the event idea data;
setting a final event data based at least in part upon the results of the event idea data voting.

23. The computer implemented method of claim 22 further comprising allowing a participant to change a vote for the event idea data and resetting a final event data based at least in part upon the changed vote.

24. The computer implemented method of claim 22 further comprising providing one or more settings in the computer implemented event planning system for allowing the organizer to disable participant event idea data submission and/or the participant voting.

25. The computer implemented method of claim 22 further comprising providing one or more settings in the computer implemented event planning system for enabling participant editing of the event idea data.

26. The computer implemented method of claim 22, further comprising providing in the computer implemented event planning system editing functionality for enabling the organizer to edit the participant submitted event idea data.

27. The computer implemented method of claim 22 further comprising providing a setting in the computer implemented event planning system capable of being selected by the organizer for setting one or more deadlines for the event idea data submission.

28. The computer implemented method of claim 27 further comprising generating the vote for the event idea data after the deadline expires.

29. The computer implemented method of claim 27 further comprising:
automatically examining the event idea data;
notifying the organizer if no event idea data is received by expiration of the deadline;
providing one or more settings in the computer implemented event planning system capable of being selected by the organizer for extending the deadline;
providing one or more settings in the computer implemented event planning system capable of being selected by the organizer for editing the event and/or cancelling the event; and
notifying the participants of one or more event updates.

30. The computer implemented method of claim 21, the data received from the organizer for initiating the new event selected from the group consisting essentially of event location data, event date data, event timeframe data, event title, invitee data and one or more system parameter selections.

31. The computer implemented method of claim 21 further comprising providing a setting in the computer implemented event planning system capable of being selected by the organizer for setting one or more response deadlines for the participant voting and/or the participant event attendance responses.

32. The computer implemented method of claim 21 further comprising providing in the computer implemented event planning system editing functionality capable of enabling an organizer to edit one or more system parameters or settings of an existing event.

33. The computer implemented method of claim 21 further comprising providing a setting in the computer implemented event planning system enabling the organizer to override the final event data and set a new final event data.

34. The computer implemented method of claim 21 further comprising providing a setting in the computer implemented event planning system enabling the participants to issue invitations to one or more additional participants for the event.

35. The computer implemented method of claim 34 further comprising providing in the computer implemented event planning system one or more settings capable of being selected for limiting a time period within additional participants may be added, to disallow the invitations from being extended after the time period.

36. The computer implemented method of claim 34, further comprising providing in the computer implemented event planning system approval functionality for the organizer to approve invitations to the additional participants prior to being issued.

37. The computer implemented method of claim 21 further comprising providing one or more settings in the computer implemented event planning system capable of being selected by the organizer for adding and/or removing one or more participants to an event.

38. The computer implemented method of claim 21 further comprising generating one or more event status notifications and displaying the event status notifications on the graphical user interface.

39. The computer implemented method of claim 38 further comprising sending one or more communication to the participants regarding the event status notifications.

40. The computer implemented method of claim 21 further comprising generating an event participant list based upon organizer supplied participant data, the event participant list capable of being imported by the computer implemented event planning system into a second event.

41. The computer implemented method of claim 21 further comprising importing the event data by the computer implemented event planning system into a second event.

42. The computer implemented method of claim 21 further comprising providing one or more settings in the computer implemented event planning system capable of being selected by the organizer for automatically determining that a participant is attending the event and/or is not attending the event, if the event attendance confirmation response is not received from the participant.

43. The computer implemented method of claim 21 further comprising providing one or more settings in the computer implemented event planning system for setting a minimum and/or maximum number of participants for an event.

44. The computer-implemented method of claim 21 further comprising setting a deadline for the participant voting and setting the final event data after the deadline has expired.

45. The computer-implemented method of claim 44 further comprising
automatically examining the voting results;
notifying the organizer if no event participant votes have been received by the computer implemented event planning system and/or there is a tie in the voting results, upon expiration of the deadline;
providing one or more computer implemented event planning system settings for extending a deadline for participant voting, capable of being selected by the organizer;
providing one or more computer implemented event planning system settings for editing the event, overriding voting results to set the final event data and/or cancelling the event, capable of being selected by the organizer; and
notifying the participants of one or more event updates.

46. The computer implemented method of claim 21 further comprising saving the final event data in a memory and importing the final event data into a second event.

47. A graphical user interface for a computer implemented event planning tool comprising:
a contact field capable of receiving user input contact data and/or contact data imported from one or more external applications, the contact data forming a listing of contacts;
an invitee field for generating an invitee list for an event capable of accepting one or more contacts from the listing contacts, the invitee list capable of being saved and imported into a second event such that all contacts of the invitee list are capable of being imported into the second event by one user selection;
a suggestion field capable of accepting one or more organizer and/or invitee input event data suggestions for display in an event data suggestion listing;
a voting field capable of accepting user input votes regarding the event data suggestion listing; and
a final event data field capable of displaying the final event data, the final event data based at least in part upon the user input votes.

48. The graphical user interface of claim 47, the event data comprising one or more of an event location, an event date, and/or an event timeframe.

49. The graphical user interface of claim 47, further comprising functionality for hiding the voting field if a setting is selected on the computer implemented event planning tool for disabling voting.

50. The graphical user interface of claim 47, further comprising functionality for hiding the event data suggestion field if a setting is selected on the computer implemented event planning tool for disabling event data suggestion submissions.

51. The graphical user interface of claim 47, the invitee field capable of accepting the contact data by the contact data being dragged and dropped into the invitee field.

52. The graphical user interface of claim 47 further comprising a setting for the invitee field to accept all contacts from the contact listing together by a single user selection.

53. The graphical user interface of claim 47 further comprising an invitee invitation field capable of receiving new invitees input by one or more invitees to be added to the invitee listing.

54. The graphical user interface of claim 53 further comprising one or more fields capable of being selected to delete one or more new invitees from the invitee listing.
